(19) United States
(12) Patent Application Publication
(10) Pub. No.: US 2009/0095740 A1
(43) Pub. Date: Apr. 16, 2009

(54) IR REFLECTIVE MATERIAL FOR COOKING

(75) Inventors: John J. BUCHALA, Tamaqua, PA (US); Glenn EHRICH, Wescosville, PA (US)

Correspondence Address: HAMRE, SCHUMANN, MUELLER & LARSON, P.C., P.O. BOX 2902, MINNEAPOLIS, MN, 55402-0902, US

(73) Assignee: SILBERLINE MANUFACTURING COMPANY, INC., Tamaqua, PA (US)

(21) Appl. No.: 12/234,196

(22) Filed: Sep. 19, 2008

Related U.S. Application Data
(60) Provisional application No. 60/998,952, filed on Oct. 15, 2007.

(51) Int. Cl. H05B 6/80; A23L 1/01

(52) U.S. Cl. 219/725; 426/243

(57) ABSTRACT

A product developed for the purpose of cooking food in a microwave oven. A microwave food-container includes metal particles in a matrix. The composition of the present invention is essentially invisible to microwave radiation but is efficient as a reflector of IR radiation. This promotes higher heat to be generated, which is more evenly applied within a container by reflecting IR energy back toward the food product while allowing microwave radiation to penetrate the container to aid in the cooking process. Such packaging for microwave use allows for efficient, thorough cooking of frozen, raw, and raw-frozen foods.

### BACKGROUND OF THE INVENTION

Conventional active-microwave food packaging is based on vacuum-metalized (VM) films. It is widely known that VM film will act as a microwave (MW) susceptor and can be used in MW ovens to convert MW radio-frequency energy to radiant heat. These VM films can be used as stand-alone heating elements but are generally utilized as laminated films combined with a paper or paperboard substrate such as can be found in MW popcorn bags (ACT II® Popcorn, Orville Redenbacher'® Popcorn) or MW heating sleeves (Hot Pockets®). An active MW food package may include the following components:
1. Kraft-type paper (may be coated with a waxy emulsion.) This is the outside layer.
2. Laminating adhesive (typically water based).
3. Metallized layer* (typically aluminum).
4. Polyester layer*. This is the inside layer which is in contact with the food. *Layers 3 and 4 are the basic components of a VM film. (Reference U.S. Pat. No. 6,896,919 B2, U.S. Pat. No. 7,015,442 B2)

While current active MW food packaging may be used for cooking food products in a MW oven, there has been a lack of commercially successful products that enable the end-user to cook larger protein-based items such as whole poultry or roasts. In addition, current MW packaging technology utilizes materials that act as microwave susceptors, becoming hot as they interact with microwave radiation.

### SUMMARY OF THE INVENTION

This invention is directed to a product for MW cooking that comprises a matrix such as a resin and metal particles dispersed in the matrix that substantially do not function as a microwave susceptor and do provide infrared radiation (IR) energy reflection properties. The product may be in the form of a relatively thin film. The present invention also is directed to cooking methods making use of the film and to food containers that make use of the product.

### BRIEF DESCRIPTION OF THE DRAWINGS

FIGS. 1-3 are graphs respectively showing the transmittance, absorption and reflectance of microwave radiation for two low density polyethylene (LDPE) films loaded with 4% IR reflective material and one LDPE film not loaded with any IR reflective material;

FIG. 4 is a schematic illustration of an apparatus used for evaluating infrared radiation transmittance and reflectance of a test film; and

FIG. 5 is a graph showing infrared radiation reflectance properties for two LDPE films loaded with 4% IR reflective material and one LDPE film not loaded with any IR reflective material.

### DETAILED DESCRIPTION

As mentioned above, the present invention is directed to a product for MW cooking that comprises a matrix such as a resin and metal particles dispersed in the matrix that substantially do not function as a microwave susceptor and do provide infrared radiation (IR) energy reflection properties. For example, the dispersed particles can be substantially transparent to MW energy. In one embodiment the dispersed particles exhibit properties such as very low microwave radiation absorption, which is typically less than 1%. Conventional microwave susceptor packaging, which is most commonly comprised of VM film, typically absorbs 25%-50% of incident microwave radiation. Thus, the product allows at least 90% of incident microwave radiation to pass through it, preferably at least 95% and more preferably at least 99%, and reflects at least 10% more incident IR radiation, preferably at least 30%, relative to binder matrix without the metal particles.

The FCC has allocated various frequencies for dielectric heating in the radio-wave and microwave portions of the radio frequency spectrum, which are also known as industrial, scientific, and medical bands or “ISM.” Microwave ovens used for domestic purposes use 2,450 MHz exclusively. Large volume Industrial heating and cooking applications typically use 915 MHz. Frequencies for the purpose of cooking in the radio frequency range are typically 27.12 MHz and 13.56 MHz.

The present invention makes use of metal particles dispersed in a resin matrix. The dispersed metal particles are essentially discrete and separate. In other words, the layer of metal particles dispersed in resin is substantially a non-contiguous metal layer. This is in contrast to the contiguous film formed by a vacuum metallization process, which acts as a microwave susceptor when used for microwave cooking purposes.

The product may be in the form of a monolayer film, i.e. a single (non-laminated) form of mass-pigmented material. “Mono-layer” materials do not incorporate any laminations, barrier layers, adhesive layers, and/or food contact layers into their design. Such products are advantageous because of the simplified manufacturing process and subsequent cost reductions. However, the product also may be in the form of a layered product in which the resin with dispersed metal particles is laminated or coated with additional layers to provide desired properties and effects.

Generally speaking, particle or flake orientation is consistent with polymer flow. In this embodiment, particle or flake orientation is substantially greater along the outer surfaces of the part and becomes less toward the innermost section of the part. This degree of orientation will vary depending on the process used to manufacture the part. Various orientations are acceptable for purposes of the present invention.

The present product eliminates several design and application issues that are encountered when using VM film. Current VM susceptor films have the following limitations:
1. The metallized layer in continuous VM films cracks when exposed to high cooking temperatures for extended periods of time. This causes the heating capacity of the film to degrade, which in turn prevents these films from being used multiple times with consistent results.
2. Continuous VM films are limited in their ability to control patterns of heat generation. To circumvent this limitation, food-packaging manufacturers have designed several packages that use patterns in VM film to focus heat to specific areas of the food product. (Reference U.S. Pat. No. 6,150,646).
3. Continuous VM films are limited in their ability to regulate the amount of heat that is generated by the film. This limitation is also circumvented by utilizing patterns in VM material in MW food packaging.
4. Cooking packaging containing VM films generally is not made of a single layer of material; rather it is made from several layers of various materials, thus involving several different manufacturing steps which ultimately affect the manufacturing cost.

MW “cooking” today generally involves heating or reheating food items. In addition, many food items, especially ready-to-eat meals, that are packaged specifically for MW cooking have been partially or completely pre-cooked (Stouffer's® entrees, Healthy Choice® entrees). In cases like these, the MW “cooking” is really meant to complete the heating or cooking process. In contrast, the present invention allows end-users using a MW oven to fully cook partially cooked, frozen or raw uncooked food products—including for example animal proteins such as meat, poultry and fish, vegetable proteins, vegetables, pastas and batter dipped and breaded products—and have them cooked to the same finish quality that typically can only be achieved by using conventional cooking methods (baking, roasting, broiling, grilling, frying, etc.). For example, the present film can be applied in cooking food products such as turkey breasts, hams and pork or beef roasts.

The present product in the form of a thin film is flexible and therefore can be utilized with existing food packaging equipment including, but not limited to, heat sealers, thermoformers, and flow wrappers. The present product can be used to form all or part of, and it can be applied to or incorporated in, various food containers. Such food containers can be open containers such as plates or trays that support a food product, closed containers such as bags or boxes that substantially or completely enclose a food product or a combination of both. The product of the present invention can be used to form all or only part of the container. This may be necessary to impart rigidity, aesthetics, structural integrity or other properties of said container.

The present invention also provides a method of cooking frozen, raw, or raw-frozen food products by applying microwave energy to such a food product supported by or enclosed in a container that includes the present product within a microwave oven. The present cooking method advantageously can cook the food product evenly and efficiently.

The present product is comprised of IR reflecting material in the form of finely divided metal particles, for example in powder or flake form, preferably an aluminum powder or flake, combined with a matrix such as, but not limited to, a thermoplastic resin. The metal particles can be incorporated into the matrix by any suitable method, such as via extrusion, thermoforming, calendaring, injection molding, or compression to form a product useful for the purpose of cooking food products. The metallic powder and/or flake often will be carried in water, solvent, plasticizer or resin binder but can also be incorporated in a dry state.

The present invention also is directed to a microwaveable food container that utilizes IR radiation reflecting particles which are transparent to microwave radiation for efficient and thorough cooking of foods including, but not limited to, those which are raw, frozen, or raw-frozen. This material can be used as packaging to contain and store the foodstuff as a sealed bag or pouch or a dish, tray, or other container. This sealed cooking system can then be placed into a microwave oven for cooking. The loading of IR reflecting particles can be varied or tailored to the specific heating requirements of the food being cooked.

The metal particles may be in the form of finely divided metal powders or flakes. The finely divided metal powder or flakes of the present invention may be composed of various suitable non-ferrous metals, their mixtures or alloys. Various geometries of the particles may be used, as described below. Coated metallic flakes with functional or aesthetics coatings also are useful in this invention. Aluminum particles are particularly useful because the native oxide layer formed on aluminum helps to maintain a practical separation between the particles even if relatively high levels of the particles are included in the product and as a result the particles are relatively close together.

Metal powders are characterized by having low aspect ratios; generally less than 10 and most typically less than 3. The aspect ratio of a particle is its length (the largest dimension of the particle) divided by its thickness (the smallest dimension measured perpendicular to the length). Metal powders are usually produced by atomization of the molten metal followed by rapid solidification, and are used commonly in powder metallurgy, as precursors for metal flakes (as described below), and, for reactive metals, in explosives and pyrotechnics. In some cases, the metal powders may be gently polished, for example in a ball mill or attritor, to smooth the surface and, in some cases, to remove some of the oxide on the surface of the powder; in order to increase the brightness of the powder to provide a more pleasing aesthetic effect. For use in the present invention, the average particle size (length) of the metal powder should be between 0.005 microns and 1000 microns, more preferably between 0.1 microns and 800 microns, and more preferably between 1 micron and 500 microns.

Metal flakes are characterized by having high aspect ratios, ranging from 10 to 10,000 typically. They are commonly used as pigments in liquid and powder coatings, inks, and plastics, both to impart desirable functional properties; such as conductivity, or to provide a barrier to oxygen or water migration; and for aesthetics enhancement; such as bright appearance at low viewing angles combined with a darker appearance at high viewing angles (the “face-flop” phenomenon) and, in some cases, color. The most common metal flake pigments are aluminum, due to its malleability and high specular reflectance. Metal flakes are most typically made by grinding metal powders or foils into small particles with high aspect ratios, using ball mills, attritors, and the like. The flakes produced by these methods can be further characterized by details of the geometry, as described below.

“Cornflake” metal flakes are characterized by having rough edges, uneven surfaces, and relatively high aspect ratios of about 50 to 2000. Their average particle size ranges from about 4 microns to about 600 microns, and their average thickness from about 0.05 microns to 0.5 microns. Examples of “cornflake” pigments are the products sold by Silberline Mfg. Co. under the Sparkle Silver® tradename.

“Silver dollar” or “lenticular” metal flakes are characterized by having (as compared to “cornflake” materials) more regular, more nearly round edges, smoother surfaces, and lower aspect ratios of about 10 to 200. Their average particle size ranges from about 4 microns to about 80 microns, and their average thickness from about 0.1 microns to 2.0 microns; and they have a narrower particle size distribution than “cornflake” materials. Examples of “silver dollar” pigments are the products sold by Silberline Mfg. Co. under the Sparkle Silver Premier® tradename. A subset of “silver dollar” flakes are “degradation resistant” products, which have similar characteristics except for somewhat lower aspect ratios, ranging from about 10 to 50. Examples of “degradation resistant silver dollar” pigments are the products sold by Silberline Mfg. Co. under the Tufflake® tradename.

An alternative method to produce metal flake pigments uses a flexible substrate which is coated with a polymeric resin release coat, followed by metallization by physical vapor deposition. The release coating is solubilized by immersion into an appropriate solvent, releasing very thin metal particles which are subsequently reduced to the desired particle size. As with other metal flake pigments, these vacuum metal deposition (“VMD”) pigments are most typically made of aluminum. Compared to metal flake pigments made by conventional grinding techniques, “VMD” pigments are much thinner and have much smoother surfaces, resulting in a very bright appearance due to enhanced specular reflectance. “VMD” pigments typically range from 0.005 to 0.05 microns (50 to 500 Angstroms) in thickness and have an average particle size of about 5 to 30 microns, with very high aspect ratios of about 100 to 10,000. Examples of “VMD” pigments are the products sold by Silberline Mfg. Co. under the StarBrite® tradename.

Particles with approximate average particle size of 9 and 55 microns have been evaluated with their respective aspect ratios falling into the range of 50 to 2000. These particles are known to display the IR reflectivity stated herein and are also transparent to microwave radiation. However, those skilled in the art will recognize that other particle sizes and aspect ratios displaying similar properties can be used as well.

The average particle size and the particle size distribution of the particles may be measured by any convenient technique. In the coatings industry, this is commonly done using laser diffraction methods, using equipment such as the Malvern Mastersizer. In order to calculate the aspect ratio, the thickness of the particles needs to be measured or calculated. An estimation of average thickness can be calculated by determining the water coverage area (WCA) for a monolayer of the material, using the procedure described by J. D. Edwards and R. I. Wray; Aluminum Paint and Powder (3^{rd} edition), pp 16 to 22, Reinhold Publishing Corp., New York (1955). As described therein, the average thickness of the particles (d, μm) is obtained according to the following equation:

d(μm)=0.4(m²×μm×g⁻¹)/WCA(m²×g⁻¹)

The composition of the present invention may be incorporated into thermoplastic, thermoset or other appropriate materials utilized as packaging for microwave-prepared foods by a variety of well known methods. This matrix material may be formed into a thin or thick film; by extrusion, calendaring, three-roll milling, and the like; which may be used as a single food package or to coat part or all of a microwave packaging container by lamination, thermoforming, and like techniques. The target thickness of the material will depend upon the exact metal powder or flake used, the degree of heating and/or browning required to cook the food, and the aesthetic effect desired. The material for food packaging should be capable of withstanding the temperature of cooking. This can be accomplished by the selection of the material itself and/or the addition of heat stability additives. The amount of the metal particles in the matrix material generally will be about 0.5% to 25%, preferably 1% to 15%, of the weight of the matrix material. The upper limit generally will be controlled by the ability to form a product that can be worked and handled readily from the practical standpoint. Products containing 1% to 15% metal particles show good performance and typically can be handled without difficulty.

Since the composition of the present invention is to be used in the preparation of food items, it is very desirable if all of the components of the composition are suitable for use in food contact applications. Each component should either be on the list of the materials that are Generally Recognized As Safe (GRAS), or should be approved for the specific application and resin system under the appropriate section of the US Code of Federal Regulations (CFR) or other appropriate regulatory authority. Such approval may not be required if the finished package utilizes a microwave-transparent coating and/or lamination which prevents direct contact of the food with the matrix material of the present invention. In this case, the microwave-transparent coating must be comprised only of materials that are suitable for use in food contact applications, as defined above, and must prevent the migration of any component of the composition of the present invention through the microwave-transparent coating to ensure that no food contact occurs. However, the utilization of such a microwave-transparent coating and/or lamination adds an additional manufacturing step and therefore increases the cost of the final product.

Examples of materials useful as the matrix include thermoplastic, thermoset or other appropriate materials such as, but not limited to, polyethylene, polypropylene, polystyrene, polyamide (“Nylon”), polyimide, polycarbonate, polyacrylate, phenolic resins (“Bakelite”), epoxy, cellulose, clay, or combinations/composites thereof. Similar materials may be used as a microwave transparent coating and/or lamination if they are GRAS or approved for the specific application and resin system under the appropriate section of the US CFR or other appropriate regulatory authority.

The present invention contemplates, for example, fabrication into, but not limited to, a one-use package, which is used to package food products for shipment from the manufacturer to the customer and then used for microwave cooking and browning of the food before being discarded; into a multiple-use package, into which food is loaded for microwave cooking and browning followed by subsequent cleaning and reuse; or into a removable, reusable insert, which is placed into a container appropriate for microwave cooking in order to achieve more even heating and cooking of the food placed therein, followed by subsequent cleaning and reuse.

Containers fabricated with the present film can be used to prepare any food which can be heated by microwave radiation, but are most effectively used to thoroughly cook food products from a raw, frozen, or raw frozen state. Examples include, but are not limited to; meats, poultry, fish, and seafood (all of which may be breaded or not); pastas, dough products such as pizzas, strombolis, pierogies, meat pies, burritos, tortillas, egg rolls, wontons, pitas, falafels, gyros and the like; and vegetables such as peppers, onions, mushrooms, eggplant, squash, tomatoes, and the like.

The invention will be illustrated by the following non-limiting examples:

### EXAMPLES

### Example 1

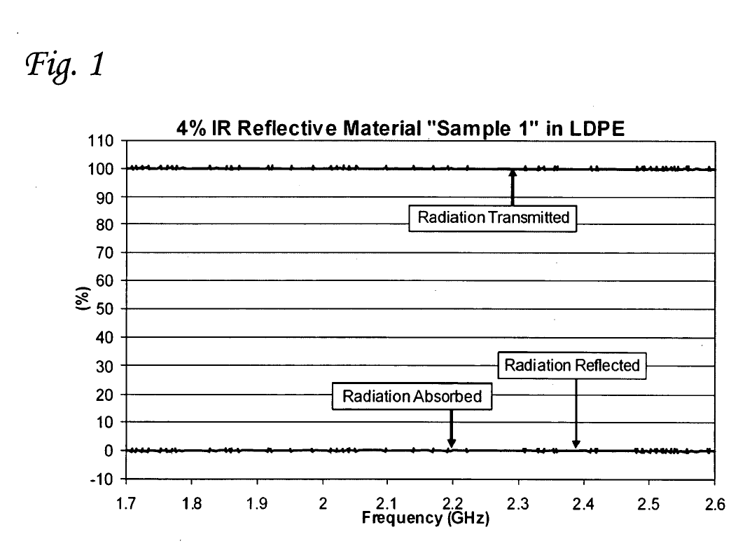

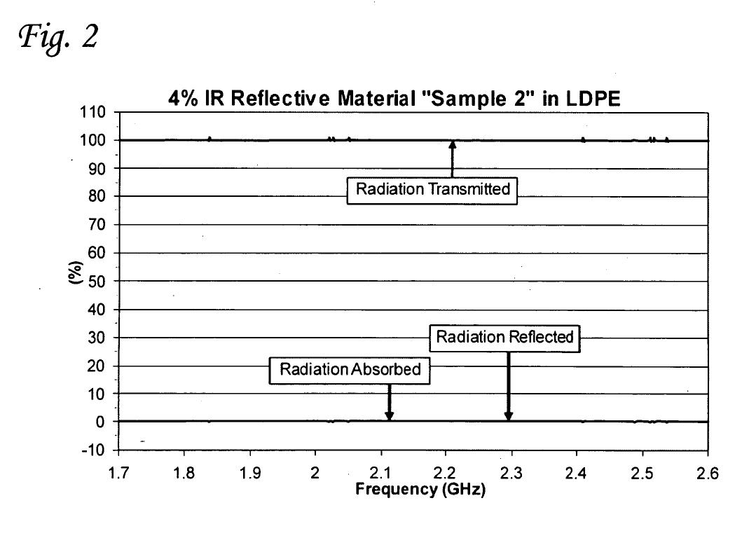

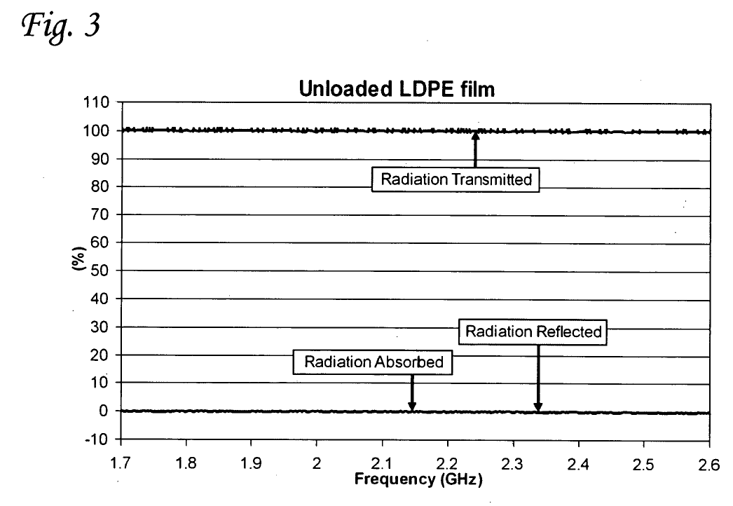

Low density polyethylene (LDPE) film containing 4% by weight IR reflecting particles (both Sample 1 and Sample 2) was produced at 2.5 mil thickness via blown film process. The metal particles used for Sample 1 were aluminum flakes of the “silver dollar” type, having an average particle size (D50) of 9 μm. The metal particles used for sample 2 were aluminum flakes of the “silver dollar” type, having an average particle size (D50) of 55 μm. The metal particles were carried into the process in pellet form using a wax-type binder. These films were then subjected to wave guide testing using an HP8510C Network Analyzer. The charts in FIGS. 1-3 show the microwave power absorbed, transmitted and reflected by each material. It can be seen that nearly 100% of the incident microwave radiation was transmitted through each sample.

### Example 2

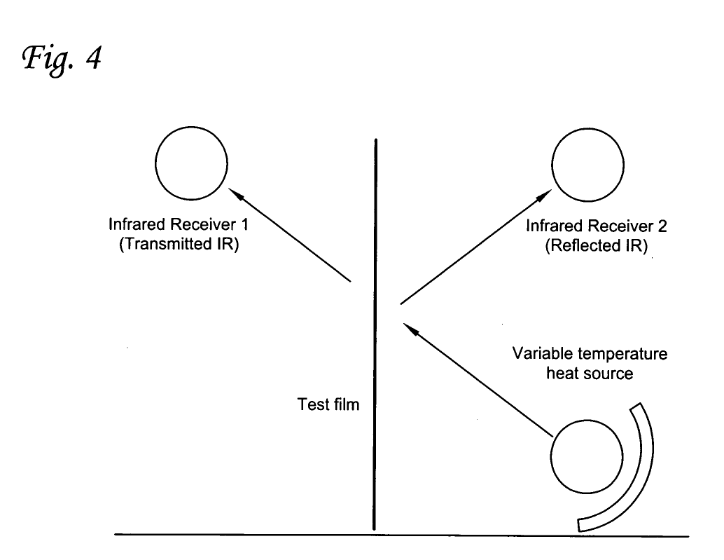

The same 4% loaded film used in example 1 is evaluated by mounting a single sheet of the LDPE IR reflector film vertically and stretched on a metal test frame. An IR source is then placed on one side of this vertical film and IR detectors are placed on both sides of the film. The IR source is then turned on and the detectors are used to quantify the amount of IR radiation that is reflected by and transmitted through the film. The diagram of FIG. 4 illustrates the test setup.

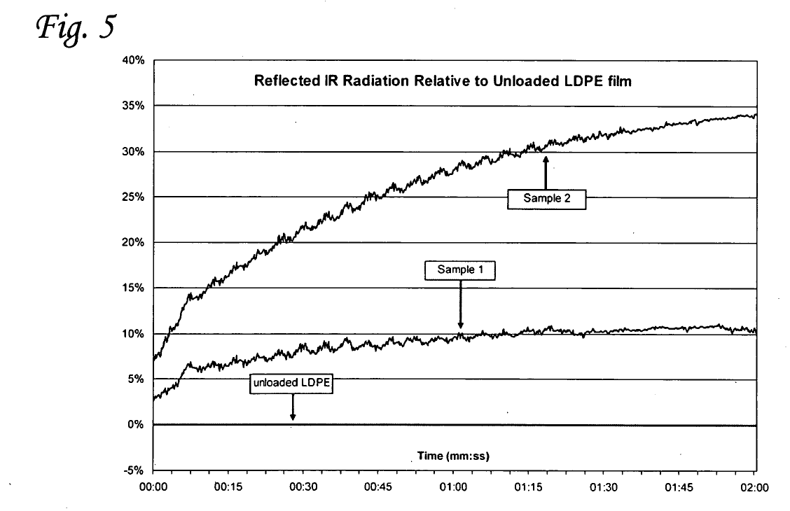

The graph of FIG. 5 shows the amount of IR radiation reflected by each film relative to the unloaded film.

It can be seen that the products of the present invention permit the transmittance of microwave radiation from a microwave generating source to a target, such as food products that are to be heated or cooked by the microwave radiation, while sufficiently reflecting infrared radiation to promote the heating effect on the food product. The present invention allows microwave ovens to cook food to a quality consistent with that of conventional ovens.

While a detailed description of the present invention has been provided above, the present invention is not limited thereto. The invention is defined by the claims that follow.

We claim:

1. A product for microwave cooking that comprises a binder matrix and metal particles dispersed in the matrix that substantially do not cause the product to function as a microwave susceptor and provide infrared radiation (IR) energy reflection properties.

2. The product of claim 1, which is in the form of material that is blown, extruded, thermoformed, calendared, injection molded, or compression formed or formed by other manufacturing equipment.

3. The product of claim 2, which is monolayer.

4. The product of claim 1, wherein the particles do not cause the product to act as a microwave susceptor for microwaves at a frequency of 2.45 GHz.

5. The product of claim 1, wherein approximately 90% or more of the incident microwave radiation is transmitted through the product.

6. The product of claim 5, wherein approximately 95% or more of the incident microwave radiation is transmitted through the product.

7. The product of claim 6, approximately 99% or more of the incident microwave radiation is transmitted through the product.

8. The product of claim 1, wherein at least 10% more incident infrared radiation is reflected by the product relative to binder matrix without the metal particles.

9. The product of claim 8, wherein at least 30% more incident infrared radiation is reflected by the product relative to binder matrix without the metal particles.

10. The product of claim 1, wherein the particles are in flake or powder form having a particle size not greater than 1000 microns

11. A food container comprising, in whole or in part, the product of claim 1.

12. The food container of claim 11, further comprising a food to be cooked.

13. The food container of claim 11, which is in the form of a package for the food.

14. A method of cooking food via the reflection and/or entrapment of IR radiation, by applying microwave energy to food present with the food container of claim 11.
